(19) United States
(12) Patent Application Publication
(10) Pub. No.: US 2025/0292463 A1
(43) Pub. Date: Sep. 18, 2025

(54) REAL-TIME TEXT-BASED DISENTANGLED REAL IMAGE EDITING

(71) Applicant: ADOBE INC., SAN JOSE, CA (US)

(72) Inventors: Zongze Wu, San Francisco, CA (US); Nicholas Isaac Kolkin, Chicago, IL (US); Richard Zhang, Burlingame, CA (US); Elya Shechtman, Seattle, WA (US)

(21) Appl. No.: 18/925,290

(22) Filed: Oct. 24, 2024

Related U.S. Application Data
(60) Provisional application No. 63/564,930, filed on Mar. 13, 2024.

(51) Int. Cl. G06T 11/60; G06T 5/50; G06T 5/70; G06V 20/70

(52) U.S. Cl. CPC G06T 11/60; G06T 5/50; G06T 5/70; G06V 20/70; G06T 2207/20221

(57) ABSTRACT

A method, apparatus, non-transitory computer readable medium, and system for image processing include obtaining an input image depicting a first element, a text description of the input image, and a modification prompt describing a second element different from the first element, generating an intermediate output based on the input image and the text description, where the intermediate output represents the first element, and generating a synthetic image based on the intermediate output and the modification prompt, where the synthetic image replaces the first element from the input image with the second element from the modification prompt.

### CROSS-REFERENCE TO RELATED APPLICATION

This application claims priority under 35 U.S.C. § 119 to U.S. Provisional Application No. 63/564,930, filed on Mar. 13, 2024, in the United States Patent and Trademark Office, the disclosure of which is incorporated by reference herein in its entirety.

### BACKGROUND

The following relates generally to image processing, and more specifically to image editing using a machine learning model. Image processing refers to the use of a computer to edit an image using an algorithm or a processing network. In some cases, image processing software can be used for various image processing tasks, such as image restoration, image detection, image generation, image compositing, and image editing. For example, image editing includes the use of a machine learning model to edit an input image based on a conditioning to generate an output image.

In the field of image editing, an input image and a text prompt are provided to a machine learning model to generate a modified image. In some cases, the text prompt includes a user instruction that describes a change of an image element from the input image. In some cases, the modified image depicts the change of the image element described by the text prompt. However, in some cases, the modified image may depict undesired changes to other image elements depicted in the input image.

### SUMMARY

Aspects of the present disclosure provide a method and system for image editing. In one aspect, the system receives an input image depicting an image element and a modification prompt depicting a modification to the image element, and generates a synthetic image depicting the modification. According to some aspects, the system includes an inversion model trained to perform image inversion and to generate an intermediate feature (or a latent feature) that represents the original image including the image element to be modified. In some aspects, the system includes an image generation model configured to generate the synthetic image based on the intermediate feature and the modification prompt describing the change from the image element to a different image element. The intermediate feature generated by the inversion model is provided to the image generation model to ensure that a target image element is modified while maintaining the remaining image elements of the input image.

A method, apparatus, non-transitory computer readable medium, and system for image processing are described. One or more aspects of the method, apparatus, non-transitory computer readable medium, and system include obtaining an input image depicting a first element and a modification prompt describing a second element different from the first element; generating, using an inversion model, an intermediate output based on the input image, wherein the intermediate output comprises image features representing the image; and generating, using an image generation model, a synthetic image based on the intermediate output and the modification prompt, wherein the synthetic image replaces the first element from the input image with the second element from the modification prompt.

A method, apparatus, non-transitory computer readable medium, and system for image processing are described. One or more aspects of the method, apparatus, non-transitory computer readable medium, and system include obtaining a training set including a training image and a training description of the image; generating, using an inversion model, an intermediate output based on the training image and the text description; generating, using an image generation model, a reconstructed image based on the intermediate output and the text description; and training the inversion model based on the training image and the reconstructed image.

An apparatus and system for image processing are described. One or more aspects of the apparatus and system include at least one processor; at least one memory storing instructions executable by the processor; an inversion model comprising parameters stored in the at least one memory and trained to generate an intermediate output based on an input image and a text description of the input image; and an image generation model comprising parameters stored in the at least one memory and trained to generate a modified image based on the intermediate output and a modification prompt, where the modified image retains an element of the input image and includes a modification based on the modification prompt.

### BRIEF DESCRIPTION OF THE DRAWINGS

FIG. 1 shows an example of an image processing system according to aspects of the present disclosure.

FIG. 2 shows an example of a method for editing an image according to aspects of the present disclosure.

FIG. 3 shows an example of text-based image editing according to aspects of the present disclosure.

FIG. 4 shows an example of image editing based on image interpolation according to aspects of the present disclosure.

FIG. 5 shows an example of an image processing apparatus according to aspects of the present disclosure.

FIG. 6 shows an example of a machine learning model according to aspects of the present disclosure.

FIG. 7 shows an example of an inversion model according to aspects of the present disclosure.

FIG. 8 shows an example of an image generation model according to aspects of the present disclosure.

FIG. 9 shows an example of a U-Net architecture according to aspects of the present disclosure.

FIG. 10 shows an example of a diffusion process according to aspects of the present disclosure.

FIG. 11 shows an example of a method for generating a modified image according to aspects of the present disclosure.

FIG. 12 shows an example of a method for training a machine learning model according to aspects of the present disclosure.

FIG. 13 shows an example of a method for training an inversion model according to aspects of the present disclosure.

FIG. 14 shows an example of a flow diagram depicting an algorithm as a step-by-step procedure in an example implementation of operations performable for training a machine learning model according to aspects of the present disclosure.

FIG. 15 shows an example of a method for training a diffusion model according to aspects of the present disclosure.

FIG. 16 shows an example of a computing device according to aspects of the present disclosure.

### DETAILED DESCRIPTION

Aspects of the present disclosure relate to image editing using generative machine learning. Some embodiments of the disclosure relate to an image generation system that accurately and efficiently generates images that depict a modification of an image element from an original image. In some aspects, the system includes an inversion model trained to perform image inversion and to generate an intermediate feature (or a latent feature) that represents the original image including the image element to be modified. In some aspects, the system includes an image generation model configured to generate a modified image based on the intermediate feature and a modification prompt describing the change from the image element to a different image element. The intermediate feature generated by the inversion model is provided to the image generation model to ensure that a target image element is modified while maintaining the remaining image elements of the input image.

In the field of image editing, a machine learning system is used to edit synthetic images generated by an image generation model, for example, a diffusion model. In some cases, a text prompt may correspond to multiple images, for example, the prompt “cat” may refer to different images depicting various cats. As a result, image inversion involves mapping a real image onto the reverse diffusion trajectory. In some cases, image reversion involves finding a noise pattern that is used during the forward diffusion process that represents or is identical to the input image.

However, conventional diffusion techniques require many diffusion steps (e.g., fifty or more steps) to invert a real image and an additional 20-50 steps to generate a new edit of the input image. As a result, the efficiency in generating modified images is decreased in image editing. Additionally, conventional image editing systems encounter challenges such as low image quality and slow processing speed.

In some cases, conventional image editing systems are unable to disentangle elements in an input image. For example, disentanglement refers to edits that alter one attribute of the input image instead of one or more attributes. Some systems use a technique of freezing attention maps in an attempt to address the aforementioned issue. However, attention control methods exert an overly restrictive influence on the generation process, which leads to insufficient changes in the image space or the introduction of artifacts. Some other techniques involve expensive optimization steps or fine-tuning synthetic paired edit data from attribute mixing when editing.

Accordingly, the present disclosure provides a system and a method that improve on conventional image generation systems by accurately and efficiently generate a synthetic image that depicts a modification described by a modification prompt. This is achieved using a system that includes an inversion model trained to generate an intermediate output (i.e., image features), and an image generation model configured to generate a synthetic image based on the intermediate output.

According to embodiments of the present disclosure, a machine learning system is trained to accurately reconstruct a real image and efficiently generate image edits. For example, given an input image and a text prompt (or a modification prompt) describing a modification to an element of the input image, the system is able to accurately and efficiently generate a modified image (or synthetic image) that depicts the modification described by the text prompt.

According to some aspects, an inversion model generates an intermediate output based on an input image. In some cases, a previous reconstructed image is also used to generate the intermediate output. In some embodiments, the inversion model is trained to iteratively generate a reconstruction of the previous reconstructed image so that the subsequent reconstructed image is more and more visually similar to or the same as the input image within 2-4 steps. For example, an image generator iteratively receives the or the intermediate output and the previous reconstructed image to generate the next reconstructed image (or the final reconstructed image at the final step). In some embodiments, the intermediate outputs are used as input to an image generation model to generate the modified image at each step. In some cases, the inversion model includes a diffusion-based inversion network trained to generate intermediate outputs based on the input image and the text description.

According to some aspects, the image generation model receives the intermediate output (generated from the inversion model) and a modified text description (or modification prompt) to generate the modified image. In some embodiments, a captioning generation model is configured to generate a text description based on the input image. For example, the modified text description includes a modification prompt. By using the modified text description, the image generation model is able to disentangle attributes in the input image. By changing one attribute in the text description, the corresponding element in the input image can be altered without altering other elements in the input image. As a result, other elements of the input image are remained, and image quality can be maintained. Accordingly, the text prompt can be edited to obtain a desired disentangled, modified image.

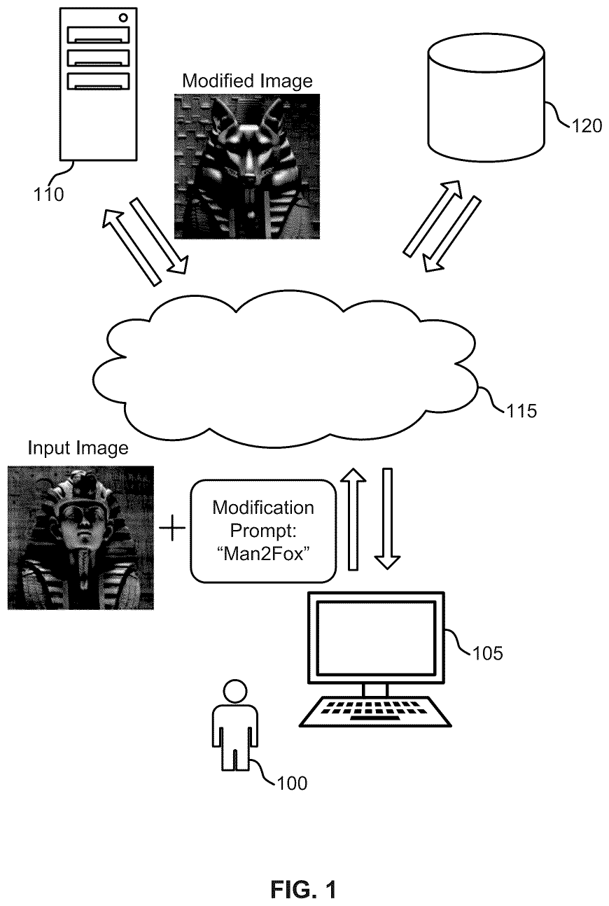

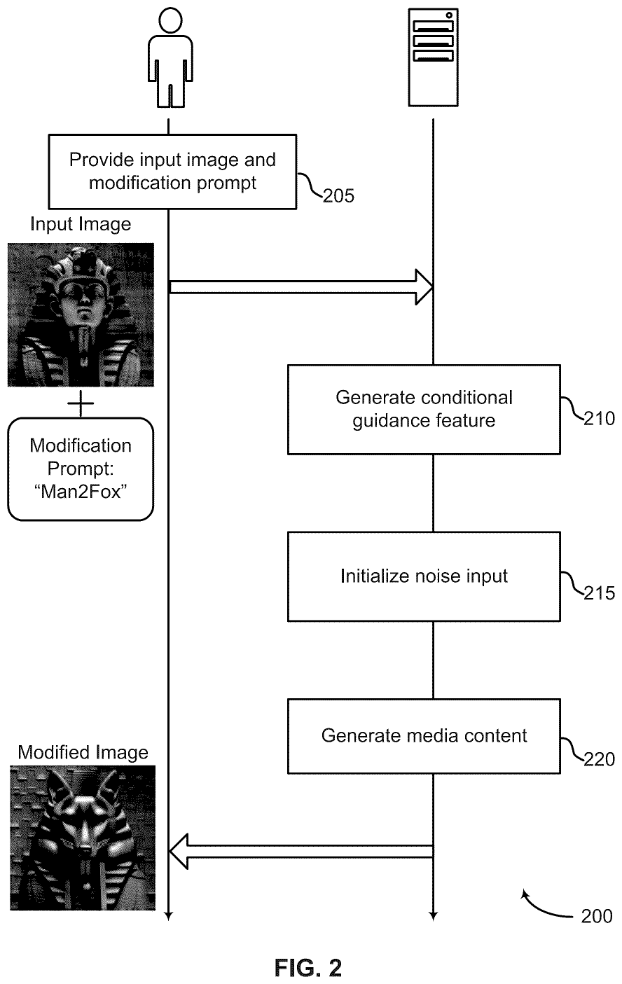

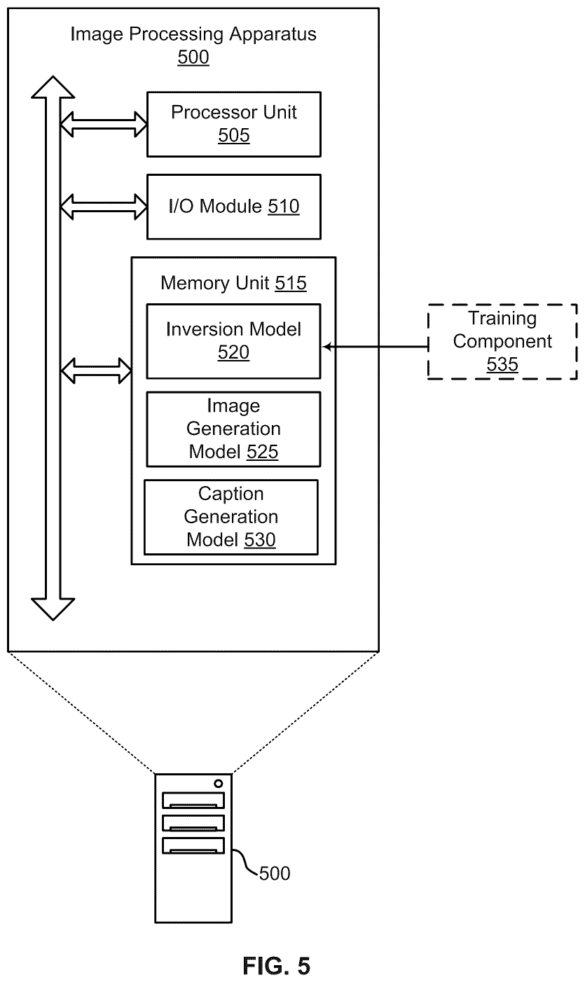

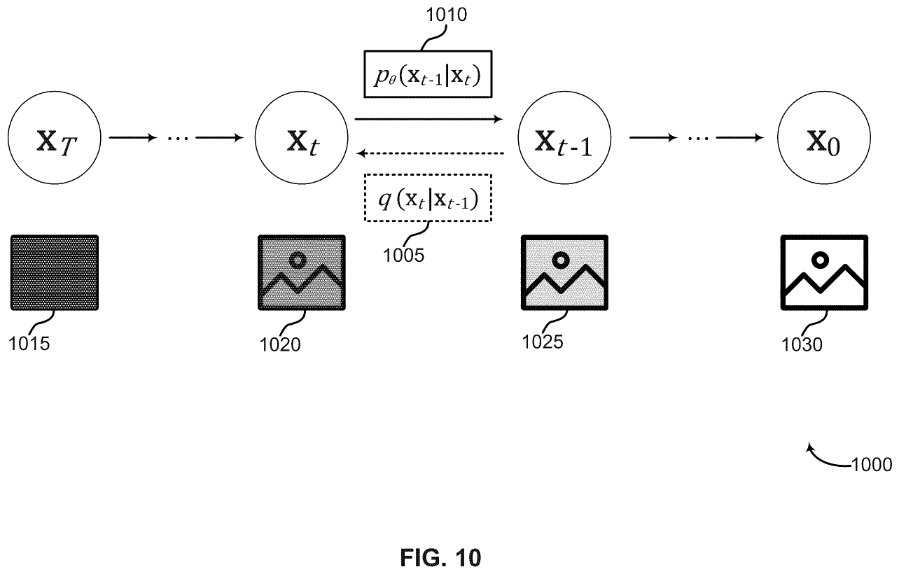

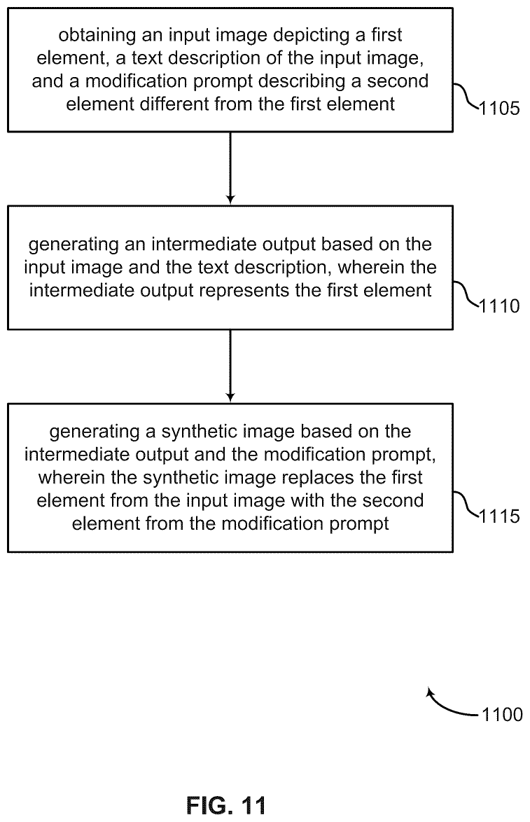

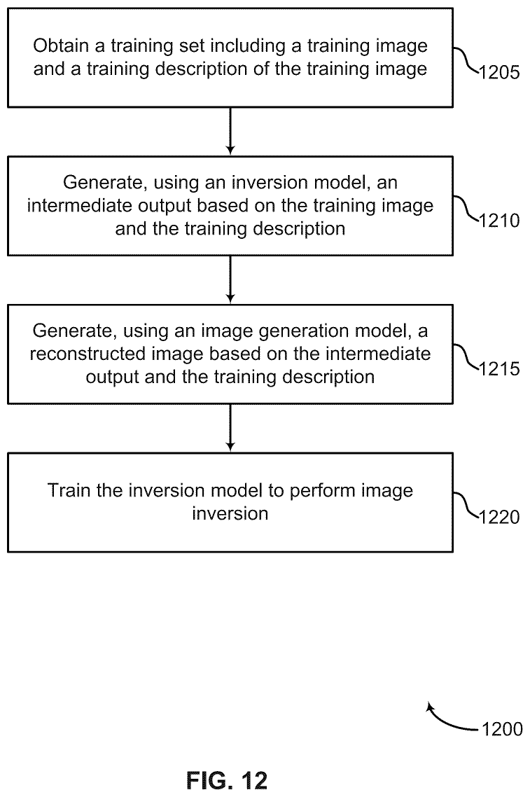

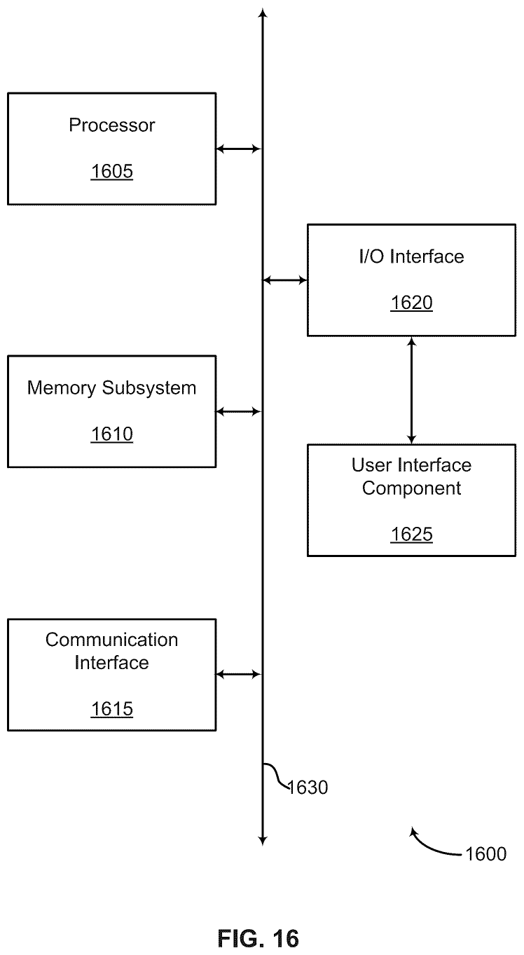

An example system of the present disclosure in image processing is provided with reference to FIGS. 1 and 16. An example application of the present disclosure in image processing is provided with reference to FIGS. 2-4. Details regarding the architecture of an image processing apparatus are provided with reference to FIGS. 5-9. An example of a process for image processing is provided with reference to FIGS. 10-11. A description of an example training process is provided with reference to FIGS. 12-15.

Accordingly, the present disclosure provides a system and a method that improve on conventional image editing systems by generating synthetic images depicting accurate edits in fewer timesteps. For example, by training the system with a modified text description that includes the modification prompt, the system is able to disentangle attributes in the input image. In some cases, the element described by the modification prompt depicted in the input image can be edited without editing other elements in the input image. By using the intermediate output generated by the inversion model, the system is able to generate the modified image within fewer steps.

### Image Editing

In FIGS. 1-4 and 10-11, a method, apparatus, non-transitory computer readable medium, and system for image processing include obtaining an input image depicting a first element, a text description of the input image, and a modification prompt describing a second element different from the first element, generating, using an inversion model, an intermediate output based on the input image and the text description, where the intermediate output represents the first element, and generating, using an image generation model, a synthetic image based on the intermediate output and the modification prompt, where the synthetic image replaces the first element from the input image with the second element from the modification prompt.

Some examples of the method, apparatus, non-transitory computer readable medium, and system further include generating the text description based on the input image. In some aspects, the modification prompt comprises an edit to the text description.

Some examples of the method, apparatus, non-transitory computer readable medium, and system further include iteratively alternating between generating successive intermediate outputs using the inversion model and the image generation model. Some examples of the method, apparatus, non-transitory computer readable medium, and system further include generating a reconstructed image based on the intermediate output, where the reconstructed image depicts the first element, and generating a subsequent intermediate output based on the reconstructed image, where the synthetic image is based on the subsequent intermediate output.

Some examples of the method, apparatus, non-transitory computer readable medium, and system further include obtaining a noise input; and denoising the noise input based on the intermediate output. In some aspects, the inversion model is trained using a training set including a training image and a training description of the training image.

According to some embodiments, a method, apparatus, non-transitory computer readable medium, and system for image processing include obtaining an input image, a text description of the input image, and a modification prompt; generating, using an inversion model, an intermediate output based on the input image and the text description; and generating, using an image generation model, a modified image based on the intermediate output and the modification prompt, where the modified image retains an element of the input image and includes a modification based on the modification prompt.

In some aspects, the modification prompt comprises an edit to the text description. In some aspects, the modification prompt comprises a description of a change to the input image. Some examples of the method, apparatus, non-transitory computer readable medium, and system further include iteratively alternating between generating successive intermediate outputs and corresponding modified images.

Some examples of the method, apparatus, non-transitory computer readable medium, and system further include generating, using the image generation model, a reconstructed image based on the intermediate output and the text description. Some examples of the method, apparatus, non-transitory computer readable medium, and system further include generating the text description based on the input image.

Some examples of the method, apparatus, non-transitory computer readable medium, and system further include adding the intermediate output to the input image to obtain a noisy image, where the image generation model takes the noisy image as an input. Some examples of the method, apparatus, non-transitory computer readable medium, and system further include performing a single-pass diffusion process.

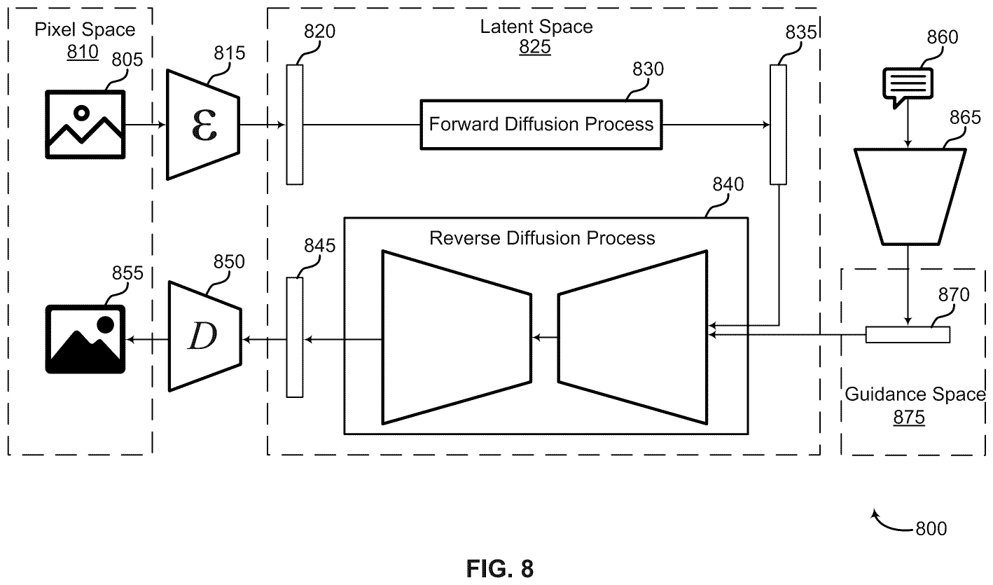

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 8.

Referring to FIG. 1, user 100 provides an input image and a modification prompt to image processing apparatus 110 via user device 105 and cloud 115. For example, the input image depicts a pharaoh. In some cases, the modification prompt states “Man2Fox”. In some cases, for example, the modification prompt indicates a change of an element from a man (or the face of the man) to a fox (or the face of the fox). In some cases, the modification prompt includes a change of an element within the input image. According to some embodiments, the image processing apparatus 110 includes an inversion model trained to generate an intermediate output based on the input image and an original text prompt. In some embodiments, the image processing apparatus includes an image generation model configured to generate the modified image based on the intermediate output and the modification prompt. In some cases, the image processing apparatus 110 generates a modified image depicting the change and displays the modified image to user 100 via the user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 5. According to some aspects, image processing apparatus 110 includes a computer implemented network comprising a machine learning model, an inversion model, an image generation model, and a caption generation model. Image processing apparatus 110 further includes a processor unit, a memory unit, an I/O module, and a training component. In some embodiments, image processing apparatus 110 further includes a communication interface, user interface components, and a bus as described with reference to FIG. 16. Additionally, image processing apparatus 110 communicates with user device 105 and database 120 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a training image and a training description of the training image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for editing an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides an input image and a modification prompt. In some cases, the operations of this step refer to, or may be performed by, a user as described with reference to FIG. 1. For example, the input image depicts a pharaoh. For example, the user provides a modification prompt “Man2Fox” to the image processing apparatus via a user interface provided by the image processing apparatus on a user device (e.g., the user device described with reference to FIG. 1). In some cases, the system may generate a text description based on the input image, and may provide the text description to the user to provide a target modification. In some cases, the modified text description is used as the modification prompt.

At operation 210, the system generates a conditional guidance feature. In some cases, the operations of this step refer to, or may be performed by, an image processing apparatus as described with reference to FIGS. 1 and 5. For example, the conditional guidance feature includes an intermediate output. In some cases, the system includes an inversion model trained to generate the intermediate output based on the input image and a previous reconstruction of the input image (or noise at the first step). In some cases, the intermediate output is generated based on the text description of the input image. Further detail on the intermediate output is described with reference to FIG.

At operation 215, the system initializes noise input. In some cases, the operations of this step refer to, or may be performed by, an image processing apparatus as described with reference to FIGS. 1 and 5. In some cases, the noise input including random noise is initialized. The noise input may be in a latent space. By initializing the image generation model with random noise, different variations of a synthetic image including the content described by the text conditioning (e.g., the text prompt) can be generated.

At operation 220, the system generates the media content. In some cases, the operations of this step refer to, or may be performed by, an image processing apparatus as described with reference to FIGS. 1 and 5. In some cases, for example, the media content includes a synthetic image or a modified image. In some cases, for example, the media content includes a synthetic image or a modified image. For example, the synthetic image includes image pixels generated by the image generation model. For example, the modified image includes image pixels from the input image and image pixels generated by the image generation model. In some cases, the image generation model receives the intermediate output and the modification prompt to generate the synthetic image.

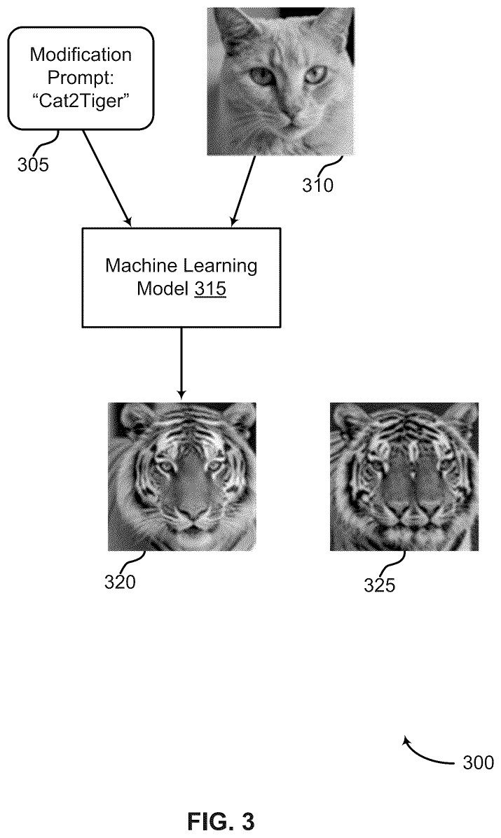

FIG. 3 shows an example of text-based image editing according to aspects of the present disclosure. The example shown includes image editing system 300, modification prompt 305, input image 310, machine learning model 315, modified image 320, and conventional output image 325.

Referring to FIG. 3, the machine learning model 315 receives input image 310 and modification prompt 305 to generate modified image 320. For example, modification prompt 305 states “Cat2Tiger” which instructs machine learning model 315 to change the object “cat” depicted in the input image 310 to a different object “tiger”. According to some embodiments, the machine learning model 315 is able to generate modified image 320 using the novel real-time text-based disentangled real image editing described with the present disclosure. In some cases, the machine learning model 315 is able to handle photo-realistic images and artistic images, control the editing strength, and perform attribute editing with large structures.

In some cases, a conventional image generation system may generate conventional output image 325 based on the modification prompt 305 and the input image 310. For example, the conventional output image 325 depicts a tiger with artifacts, such as overlapping facial elements. As a result, conventional systems are unable to accurately generate an output image based on the given inputs.

According to some embodiments, an input image is provided to a caption generation model to generate a text description describing the input image. In some cases, for example, the text description states “a young man wearing a brown trench coat (, a hat,) and a grey t-shirt with black hair, standing in front of subtropical flowers (in heavy snow). He is looking directly at the camera, giving a sense of focus and determination. The coat is open, revealing the man's attire underneath. The overall scene is well-lit, with the man being the main subject of the image.” In some cases, the modification prompts are used to replace the italicized text in the text description to generate one or more modified images.

Conventional techniques in diffusion models include attention-based image editing to preserve structural similarities between the source and target images. For example, conventional techniques freeze the self-attention layer and cross-attention layers in the U-Net of the diffusion model. However, the effectiveness of these methods depends on the number of time steps over which attention control is applied. In some cases, applying attention control over many time steps results in the target image being identical to the source image, but lacking the target attribute described by the text prompt. On the other hand, applying attention control over a small number of time steps leads to the target image containing the desired attribute but deviating significantly from the source image. As a result, conventional techniques require computing an optimal number of steps for applying attention control to be tuned on a case-by-case basis to achieve the balance between structural preservation and editability.

In the field of few-step diffusion models, the scope of tuning this parameter is constrained due to the limited amount of time steps (e.g., 1-4 time steps). In some cases, when the editing necessitates a substantial structural modification (e.g., cat to tiger transformation), conventional models (e.g., one-step and four-step diffusion models) are unable to generate satisfactory edited images.

In some cases, the trajectory of sampling in diffusion models is influenced by the initial noise x_{T}, injected noise ϵₜ, and the text condition c. In some cases, the initial noise x_{T} and the injected noise ϵₜ are randomly sampled from Gaussian distributions with spatial dimensions, which influences the image layout. Conventional techniques showcase that merely freezing the initial noise x_{T} and the injected noise ϵₜ are insufficient to preserve the structure of the modified image.

Accordingly, when a text prompt is highly detailed and encompasses semantic information across various attributes, modifying a single attribute in the text prompt results in a minor change in the text embedding. As a result, the two sampling trajectories can remain sufficiently close, showcasing that the modified image and the input can be nearly identical except for the modified attribute. In some cases, a lengthy text prompt might not be provided. As a result, a pre-trained language model can be used to expand a short text prompt to a long description. For example, the language model is configured to “please describe an image of a {short caption} in detail”, where the language model generates long and detailed text descriptions comprising fifty to one hundred words. Then, an attribute can be modified based on the text description, for example, changing the corresponding instances of “cat” to “tiger”. By using the same random seed, which implies the same initial noise x_{T} and the injected noise ϵₜ, the source and target text prompts may generate substantially identical images that differ in the modified attribute.

In some cases, in one-shot diffusion models, attention control techniques exert an overly restrictive influence on the generation process, leading to insufficient changes in the image space (e.g., horse to unicorn) or the introduction of artifacts (e.g., fox to dog). In some cases, attention control can lead to either inadequate preservation of structure or the occurrence of artifacts demonstrated by conventional output image 325, especially in the case where the editing requires significant structural modifications.

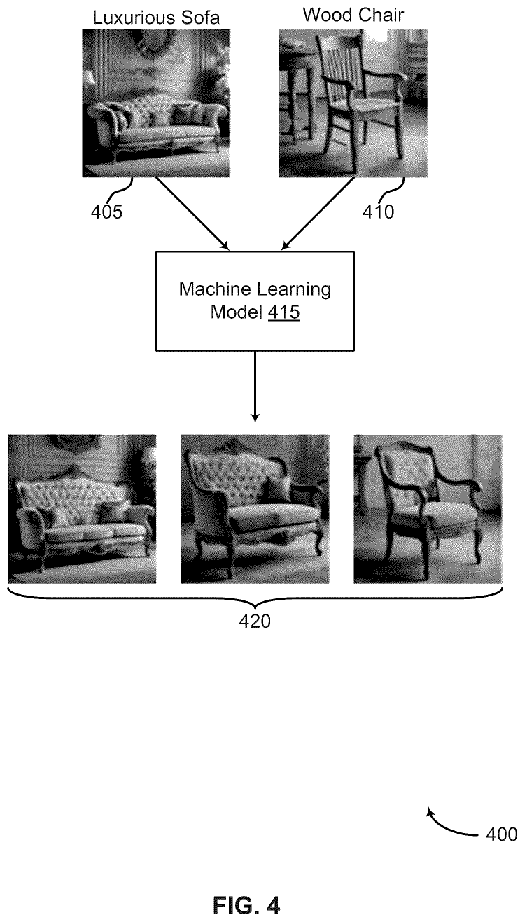

FIG. 4 shows an example of image editing based on image interpolation according to aspects of the present disclosure. The example shown includes image generation system 400, first input image 405, second input image 410, machine learning model 415, and modified images 420.

Referring to FIG. 4, first input image 405 and second input image 410 are provided to the machine learning model 415 to generate modified images 420 that include a plurality of images depicting a transformation from the first input image 405 to the second input image 410. In some cases, for example, the modified images 420 depict an edit to one or more image elements from the first input image 405 or the second input image 410.

### System Architecture

In FIGS. 5-9 and 16, an apparatus and system for image processing are described. One or more aspects of the apparatus and system include at least one processor; at least one memory storing instructions executable by the processor; an inversion model comprising parameters stored in the at least one memory and trained to generate an intermediate output based on an input image and a text description of the input image; and an image generation model comprising parameters stored in the at least one memory and trained to generate a modified image based on the intermediate output and a modification prompt, where the modified image retains an element of the input image and includes a modification based on the modification prompt.

In some aspects, the image generation model comprises a single-pass or a few-pass diffusion model. In some aspects, the inversion model has a same architecture as the image generation model. Some examples of the apparatus and system further include a caption generation model configured to generate the text description based on the input image.

Some examples of the apparatus and system further include a user interface comprising an input image display element, a modified image display element, a text description field, and a modification prompt field. In some aspects, the user interface further comprises a selection element indicating a balance between the text description and the modification prompt.

FIG. 5 shows an example of an image processing apparatus 500 according to aspects of the present disclosure. The example shown includes image processing apparatus 500, processor unit 505, I/O module 510, memory unit 515, and training component 535. In one aspect, memory unit 515 includes inversion model 520, image generation model 525, and caption generation model 530. In some cases, the processor unit 505 may be referred to as a processing device. In some cases, the memory unit 515 may be referred to as the memory component.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 16.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

In one aspect, memory unit 515 includes a machine learning model, inversion model 520, image generation model 525, and caption generation model 530. Memory unit 515 is an example, of, or includes aspects of, the memory subsystem described with reference to FIG. 16.

In some cases, the machine learning model is a computational algorithm, model, or system designed to recognize patterns, make predictions, or perform a specific task (for example, image processing) without being explicitly programmed. According to some aspects, machine learning model is implemented as software stored in memory unit 515 and executable by processor unit 505, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of the elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, machine learning model obtains an input image, a text description of the input image, and a modification prompt. Machine learning model is an example of, or includes aspects of, the corresponding element described with reference to FIGS. 3 and 4.

According to some aspects, inversion model 520 is implemented as software stored in memory unit 515 and executable by processor unit 505, as firmware, as one or more hardware circuits, or as a combination thereof. According to some aspects, inversion model 520 generates an intermediate output based on the input image and the text description. In some examples, inversion model 520 iteratively alternates between generating successive intermediate outputs and corresponding modified images. According to some aspects, inversion model 520 generates an intermediate output based on the training image and the text description.

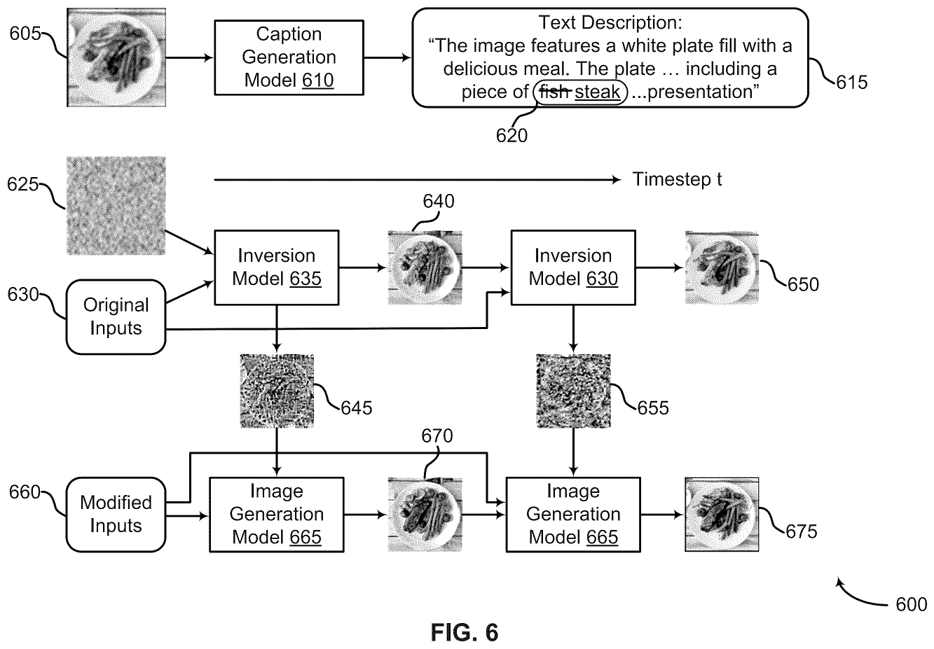

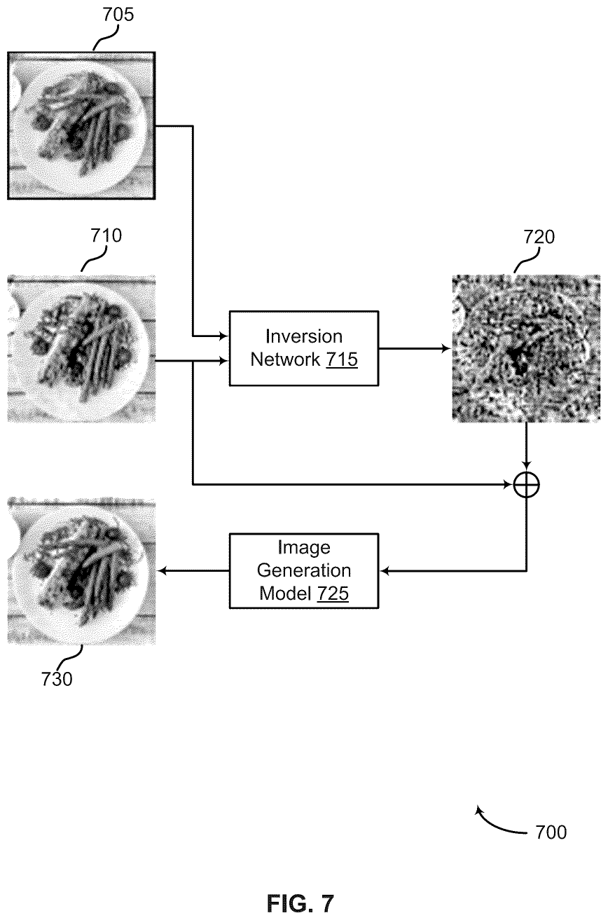

According to some aspects, inversion model 520 comprises parameters stored in the at least one memory and trained to generate an intermediate output based on an input image and a text description of the input image. In some aspects, the inversion model 520 has a same architecture as the image generation model 525. Inversion model 520 is an example of, or includes aspects of, the corresponding element described with reference to FIGS. 6 and 7.

According to some aspects, image generation model 525 is implemented as software stored in memory unit 515 and executable by processor unit 505, as firmware, as one or more hardware circuits, or as a combination thereof. According to some aspects, image generation model 525 generates a modified image based on the intermediate output and the modification prompt, where the modified image retains an element of the input image and includes a modification based on the modification prompt. In some examples, image generation model 525 generates a reconstructed image based on the intermediate output and the text description. In some examples, image generation model 525 ads the intermediate output to the input image to obtain a noisy image, where the image generation model 525 takes the noisy image as an input. In some examples, image generation model 525 performs a single-pass diffusion process.

According to some aspects, image generation model 525 generates a reconstructed image based on the intermediate output and the text description. In some examples, image generation model 525 generates a modified image based on the intermediate output and a modification prompt. According to some aspects, image generation model 525 comprises parameters stored in the at least one memory and trained to generate a modified image based on the intermediate output and a modification prompt, where the modified image retains an element of the input image and includes a modification based on the modification prompt. In some aspects, the image generation model 525 includes a single-pass or a few-pass diffusion model. Image generation model 525 is an example of, or includes aspects of, the corresponding element described with reference to FIGS. 6 and 7.

According to some aspects, caption generation model 530 is implemented as software stored in memory unit 515 and executable by processor unit 505, as firmware, as one or more hardware circuits, or as a combination thereof. In some aspects, the modification prompt includes an edit to the text description. In some aspects, the modification prompt includes a description of a change to the input image. In some examples, caption generation model 530 generates the text description based on the input image. According to some aspects, caption generation model 530 is configured to generate the text description based on the input image. Caption generation model 530 is an example of, or includes aspects of, the corresponding element described with reference to FIG. 6.

According to some aspects, training component 535 is implemented as software stored in memory unit 515 and executable by processor unit 505, as firmware, as one or more hardware circuits, or as a combination thereof. According to some embodiments, training component 535 is implemented as software stored in a memory unit and executable by a processor in the processor unit of a separate computing device, as firmware in the separate computing device, as one or more hardware circuits of the separate computing device, or as a combination thereof. In some examples, training component 535 is part of another apparatus other than image processing apparatus 500 and communicates with the image processing apparatus 500. In some examples, training component 535 is part of image processing apparatus 500.

According to some aspects, training component 535 obtains a training set including a training image and a training description of the image. In some examples, training component 535 trains the inversion model 520 based on the training image and the reconstructed image. In some examples, training component 535 generates the training description based on the training image. In some examples, training component 535 computes a reconstruction loss based on the training image and the reconstructed image. In some examples, training component 535 updates parameters of the inversion model 520 based on the reconstruction loss. In some examples, training component 535 computes a modification loss based on the modified image and a ground-truth modified image. In some examples, training component 535 updates parameters of the inversion model 520 based on the modification loss. In some examples, training component 535 initializes the inversion model 520 using parameters from the image generation model 525. In some aspects, the image generation model 525 is fixed during the training of the inversion model 520.

FIG. 6 shows an example of a machine learning model 600 according to aspects of the present disclosure. The example shown includes machine learning model 600, input image 605, caption generation model 610, text description 615, modification prompt 620, noise input 625, original inputs 630, inversion model 635, first reconstruction image 640, first intermediate output 645, second reconstruction image 650, second intermediate output 655, modified inputs 660, image generation model 665, first modified image 670, and final modified image 675.

Referring to FIG. 6, machine learning model 600 receives the input image 605 and the modification prompt 620, and generates the final modified image 375. According to some embodiments, the caption generation model 610 receives the input image 605 to generate text description 615. In some cases, the input image 605 depicts a plate of food. In some cases, the text description 615 describes the input image 605 as “The image features a white plate filled with a delicious meal. The plate is topped with a variety of food items, including a piece of fish, asparagus, and tomatoes. The fish is placed towards the center of the plate while the asparagus and tomatoes are scattered around it. The arrangement of the food item creates a visually appealing and appetizing presentation.” In some cases, the modification prompt 620 modifies an element from the text description 615. For example, the modification prompt 620 replaces fish with steak. For example, the modification prompt 620 provides an input to the machine learning model 600 to generate a synthetic image (e.g., the final modified image 375) depicting a change from fish on the white plate to a steak on the same plate, while maintaining other elements of the input image 605.

In some embodiments, the inversion model 635 receives a noise input 625 and original inputs 630 to generate first reconstruction image 640 at a first timestep. For example, the noise input 625 may include random noise or may be a noise map. For example, the original inputs 630 include input image 605, text description 615, and the current timestep. In some cases, the first reconstruction image 640 may include substantially the same visual features/elements as the visual features/elements of the input image 605. In some embodiments, the inversion model 635 generates first intermediate output 645 based on the noise input 625 and the original inputs 630. In some cases, the first intermediate output 645 may be a latent representation (e.g., latent features, visual features, latent codes, or a combination thereof) of the first reconstruction image 640.

In some embodiments, during a second timestep (or a subsequent timestep), the inversion model 635 receives the first reconstruction image 640 and original inputs 630 to generate second reconstruction image 650 at a second timestep or a subsequent timestep. In some cases, for example, the second reconstruction image 650 may include substantially the same visual features/elements as the visual features/elements of the input image 605. In some embodiments, the inversion model 635 generates second intermediate output 655 based on the first reconstruction image 640 and original inputs 630. In some cases, the second intermediate output 655 may be a latent representation of the second reconstruction image 650.

In some embodiments, the image generation model 665 is configured to generate a synthetic image (e.g., the first modified image 670 or the final modified image 675) based on the modified inputs 660 and the corresponding intermediate output (e.g., the first intermediate output 645 or the second intermediate output 655). For example, the image generation model 665 receives the modified inputs 660 and the first intermediate output 645 to generate first modified image 670. In some cases, the modified inputs 660 include modification prompt 620 and the corresponding timestep. For example, the first intermediate output 645 is provided to the image generation model 665 to initiate the image generation process, and the modification prompt 620 of the modified inputs 660 is used to guide the image generation process (e.g., the reverse diffusion process). Further detail on the reverse diffusion process is described with reference to FIG. 8.

In some embodiments, the image generation model 665 receives the first modified image 670, the modified inputs 660, and the second intermediate output 655 to generate the final modified image 675. In some cases, the second intermediate output 655 is provided to the image generation model 665 to initiate the image generation process. In some cases, for example, the first modified image 670 and the modified inputs 660 are provided to a multi-modal encoder to generate embeddings (or a concatenated embedding), where the embeddings are used to guide the reverse diffusion process of the image generation model 665 to generate the final modified image 675.

In the field of diffusion models, the forward diffusion process gradually transforms a clean image x₀ into white Gaussian noise x_{T} by iteratively adding Gaussian noise nₜ to the clean image,

$${x}_{t} = \sqrt{1 - {β}_{t}} {x}_{t - 1} + \sqrt{{β}_{t}} {n}_{t} \qquad ( 1 )$$

where βₜ represents the noise schedule. In some cases, this process can be rewritten to:

$${x}_{t} = \sqrt{{α}_{t}} {x}_{0} + \sqrt{1 - {\overline{α}}_{t}} {ϵ}_{t} \qquad ( 2 )$$

where αₜ=1−βₜ, α̅ₜ=Πᵢ₌ᵢ^{t}αᵢ, and ϵₜ represents Gaussian noise. A network \hat{ϵ}_{θ} is trained to generate ϵₜ given xₜ, text prompt t, and time step t with the loss function:

$$L ( {\hat{ϵ}}_{θ} ) = {𝔼}_{{x}_{0} ∼ q ; {ϵ}_{t} ∼ N ( 0 , 1 )} [ {‖ {\hat{ϵ}}_{θ} ( \sqrt{{α}_{t}} {x}_{0} + \sqrt{1 - {\overline{α}}_{t}} {\hat{ϵ}}_{t} , c , t ) - {ϵ}_{t} ‖}^{2} ] \qquad ( 3 )$$

During the sampling process, a sample xₜ₋₁ can be generated from xₜ through

$${x}_{t - 1} = \sqrt{{α}_{t - 1}} ( \frac{{x}_{t} - \sqrt{1 - {α}_{t}} {\hat{ϵ}}_{θ} ( {x}_{t} , c , t )}{\sqrt{{α}_{t}}} ) + \sqrt{1 - {α}_{t - 1} - {σ}_{t}^{2}} {\hat{ϵ}}_{θ} ( {x}_{t} , c , t ) + {σ}_{t} {ϵ}_{t} \qquad ( 4 )$$

where σₜ=\sqrt{1−αₜ₋₁/1−αₜ}\sqrt{1−αₜ/αₜ₋₁}. In some cases, the network can generate the predicted x₀ at time step t through

$${x}_{0 , t} = \frac{{x}_{t} - \sqrt{1 - {α}_{t}} {\hat{ϵ}}_{θ} ( {x}_{t} , c , t )}{\sqrt{{α}_{t}}} \qquad ( 5 )$$

In some cases, the model takes 20-50 steps from a sampled Gaussian noise xₜ to a clean image x₀. In some cases, the image generation model 665 of the disclosure can obtain high-quality images in 1-4 steps.

Given an input real image x₀ (e.g., the input image 605), a caption generation model 610 generates a detailed caption c (e.g., the text description 615). In some cases, an attribute in c can be modified to create a new text prompt c′ (e.g., the modification prompt 620). Given the detailed nature of the c and the minor nature of the attribute modification, c and c′ may be substantially similar. The inversion process begins by feeding the x₀, c, current time step t, and a previous reconstructed image x_{0,t+1} (initially as a zero matrix) into the inversion model 635. The inversion model 635 then generates the noise ϵₜ (e.g., the first intermediate output 645), which is fed into image generation model 665 to generate the new construction image x_{0,0} (e.g., the first reconstruction image 640), which would be similar to input image x₀. The inversion process iterates from t=T to smaller t by first encoding semantic information and then capturing finer details. The noise ϵₜ includes spatial information not explicitly encoded in c. Given the final inverted noise ϵₜ, along with c, the image generation model 665 is used to generate an inversion trajectory and reconstruct image x_{0,0}, which would be similar to input image x₀. Using the same noises ϵₜ and slightly different text prompt c′ (e.g., the modification prompt 620), starting from t=T to smaller t, the editing trajectory may be similar to the inversion trajectory, and the modified image may closely resemble the input image 605, differing in the specified attribute in c′.

Machine learning model 600 is an example of, or includes aspects of, the corresponding element described with reference to FIGS. 3 and 5. Input image 605 is an example of, or includes aspects of, the corresponding element described with reference to FIGS. 3 and 7. Caption generation model 610 is an example of, or includes aspects of, the corresponding element described with reference to FIG. 5. Modification prompt 620 is an example of, or includes aspects of, the corresponding element described with reference to FIG. 3.

Inversion model 635 is an example of, or includes aspects of, the corresponding element described with reference to FIGS. 5 and 7. first reconstruction image 640 is an example of, or includes aspects of, the corresponding element described with reference to FIG. 7. First intermediate output 645 is an example of, or includes aspects of, the corresponding element described with reference to FIG. 7. Image generation model 665 is an example of, or includes aspects of, the corresponding element described with reference to FIGS. 5 and 7.

FIG. 7 shows an example of an inversion model 700 according to aspects of the present disclosure. The example shown includes inversion model 700, input image 705, first reconstruction image 710, inversion network 715, intermediate output 720, image generation model 725, and second reconstruction image 730. In one aspect, the inversion model 700 includes an inversion network 715. In an embodiment, the inversion model 700 includes an inversion network 715 and an image generation model 725.

Referring to FIG. 7, a generator (e.g., the image generation model 725) receives time step t, text prompt c, and noisy image xₜ=x₀+ϵₜ and outputs an intermediate reconstruction image x_{0,t} (e.g., second reconstruction image 730). In some cases, the model can generate the clean image x_{0,t} from a noisy version using the following

$${x}_{0 , t} = G ( t , c , {x}_{t} ) \qquad ( 6 )$$

In some embodiments, the inversion network 715 is used in a single-step approach where t=T. Given a real image x₀ and corresponding text prompt c, inversion network 715 F_{single} is trained to generate ϵ_{T} (e.g., the intermediate output 720), such that when ϵ_{T} is fed into G (e.g., the image generation model 725), the x_{0,t} may be the same as x₀ by using the following loss function:

$$L ( {F}_{single} ) = {𝔼}_{{x}_{0} ∼ q} [ {‖ {x}_{0} - G ( t , c , {\hat{x}}_{t} ) ‖}^{2} ] , where \qquad ( 7 )$$

$${\hat{x}}_{t} = \sqrt{{α}_{t}} {x}_{0} + \sqrt{1 - {\overline{α}}_{t}} {F}_{single} ( T , c , {x}_{0} )$$

Inversion network 715 is initialized from G (e.g., image generation model 725), where G is frozen during training. The information of input image x₀ is stored in text prompt c (e.g., global information) and ϵ_{T}=F_{single} (T, c, x₀) (e.g., spatial information). Then, to perform image editing, modification prompt c′ is used, where the modified image can be represented as:

$${x}_{0 , T}^{′} = G ( T , {c}^{′} , {\hat{x}}_{t} ) , {\hat{x}}_{t} = \sqrt{{\overline{α}}_{t}} {x}_{0} + \sqrt{1 - {\overline{α}}_{t}} {F}_{single} ( T , c , {x}_{0} ) \qquad ( 8 )$$

According to some embodiments, the single-step encoder method described above performs semantic edits while preserving background details.

According to some embodiments, the inversion process is iteratively performed to refine the reconstruction images. For example, inversion network 715 is used to take the input image x₀ along with the reconstruction from the previous step x_{0,t+1}, and generates predicted noise ϵₜ (e.g., the intermediate output 720) for the current timestep. The injected noise ϵₜ is combined (via concatenation) with the previous reconstruction x_{0,t+1} to generate a new noisy image xₜ using the image generation model 725 to obtain the new construction image x_{0,t}. Additionally, a multi-step training loss can be formed as follows:

$${L}_{MSE} ( F ) = {𝔼}_{{x}_{0} ∼ q} [ {‖ {x}_{0} - G ( t , c , {\hat{x}}_{t} ) ‖}^{2} ] , where \qquad ( 9 )$$

$${\hat{x}}_{t} = \sqrt{{\overline{α}}_{t}} {x}_{0 , t + 1} + \sqrt{1 - {\overline{α}}_{t}} F ( T , c , {x}_{0} , {x}_{0 , t + 1} )$$

In some embodiments, the image generation model 725 takes first reconstruction image 710 as input, and as a result, the loss function pushes inversion network 715 to output a noise ϵₜ which enhances the first reconstruction image 710 relative to the input image 705. During training, at time-step t=T, a zero matrix is used as first reconstruction image 710.

In some embodiments, a reparameterization method is used to constrain the injected noise to distribution close to standard Gaussian to prevent a high value of predicted noise and excessive structural information from the input image, which may result in additional artifacts in the reconstruction image. In some cases, the inversion network 715 generates the mean and variance of each pixel, from which the injected noise is sampled. The KL loss for this modification can be represented as:

$${L}_{KL} ( F ) = {𝔼}_{{x}_{0} ∼ q} [ KL ( F ( T , c , {x}_{0} , {x}_{0 , t + 1} ) , N ( 0 , 1 ) ) ] \qquad ( 10 )$$

Accordingly, the total loss can be represented as:

$$L ( E ) = {L}_{MSE} ( F ) + λ * {L}_{KL} ( F ) \qquad ( 11 )$$

In some cases, the hyperparameter λ is set to λ=10⁻⁶.

According to some aspects, after training the machine learning model, the model can perform both inversion and editing as shown in FIG. 6. In some cases, inversion model 700 and image generation model 725 are iterated to output ϵₜ. In some cases, ϵₜ includes different levels of spatial information of input image x₀. For example, ϵₜ with large T includes spatial semantic information, while ϵₜ with small t include fine details. Using the generated intermediate output ϵₜ and new text prompt c′, the machine learning model can generate a new image (e.g., modified image) resembling the input image x₀ while including the target attribute described in c′.

FIG. 8 shows an example of an image generation model according to aspects of the present disclosure. The example shown includes diffusion model 800, original image 805, pixel space 810, image encoder 815, original image feature 820, latent space 825, forward diffusion process 830, noisy feature 835, reverse diffusion process 840, denoised image feature 845, image decoder 850, output image 855, text prompt 860, text encoder 865, guidance feature 870, and guidance space 875.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image, or to image features generated by an encoder (e.g., latent diffusion).

Diffusion models work by iteratively adding noise to the data during a forward process and then learning to recover the data by denoising the data during a reverse process. For example, during training, diffusion model 800 may take an original image 805 in a pixel space 810 as input and apply an image encoder 815 to convert original image 805 into original image feature 820 in a latent space 825. Then, a forward diffusion process 830 gradually adds noise to the original image feature 820 to obtain noisy feature 835 (also in latent space 825) at various noise levels.

Next, a reverse diffusion process 840 (e.g., a U-Net ANN) gradually removes the noise from the noisy feature 835 at the various noise levels to obtain the denoised image feature 845 in latent space 825. In some examples, denoised image feature 845 is compared to the original image feature 820 at each of the various noise levels, and parameters of the reverse diffusion process 840 of the diffusion model are updated based on the comparison. Finally, an image decoder 850 decodes the denoised image feature 845 to obtain an output image 855 in pixel space 810. In some cases, an output image 855 is created at each of the various noise levels. The output image 855 can be compared to the original image 805 to train the reverse diffusion process 840. In some cases, output image 855 refers to the synthetic image (e.g., described with reference to FIGS. 3, 4, and 6).

In some cases, image encoder 815 and image decoder 850 are pre-trained prior to training the reverse diffusion process 840. In some examples, image encoder 815 and image decoder 850 are trained jointly, or the image encoder 815 and image decoder 850 are fine-tuned jointly with the reverse diffusion process 840.

The reverse diffusion process 840 can also be guided based on a text prompt 860, or another guidance prompt, such as an image, a layout, a style, a color, a segmentation map, etc. The text prompt 860 can be encoded using a text encoder 865 (e.g., a multimodal encoder) to obtain guidance feature 870 in guidance space 875. The guidance feature 870 can be combined with the noisy feature 835 at one or more layers of the reverse diffusion process 840 to ensure that the output image 855 includes content described by the text prompt 860. For example, guidance feature 870 can be combined with the noisy feature 835 using a cross-attention block within the reverse diffusion process 840.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

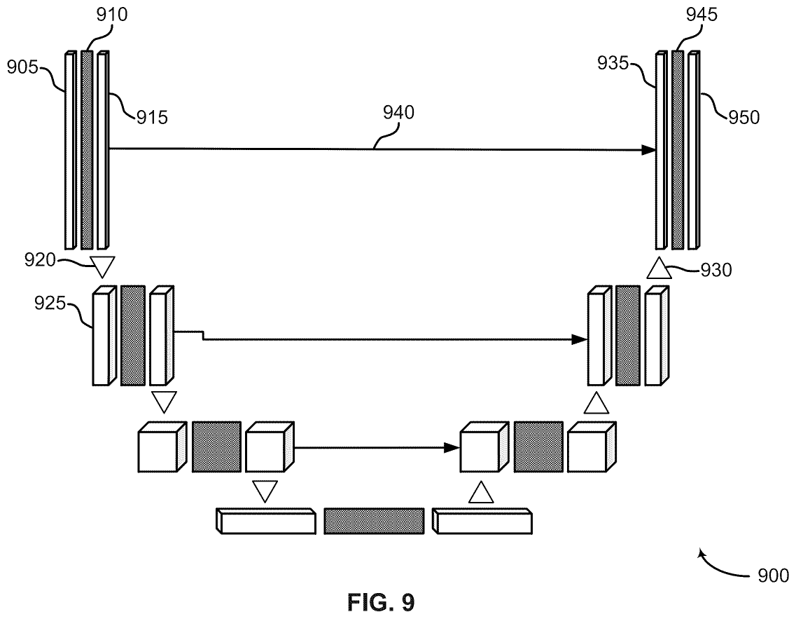

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 9.

A diffusion process may also be modified based on conditional guidance. In some cases, a user provides a text prompt (e.g., text prompt 860) describing content to be included in a generated image. In some examples, guidance can be provided in a form other than text, such as via an image, a sketch, a color, a style, or a layout. The system converts text prompt 860 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 800 generates an image based on the noise map and the conditional guidance vector.

A diffusion process can include both a forward diffusion process 830 for adding noise to an image (e.g., original image 805) or features (e.g., original image feature 820) in a latent space 825 and a reverse diffusion process 840 for denoising the images (or features) to obtain a denoised image (e.g., output image 855). The forward diffusion process 830 can be represented as q(xₜ|xₜ₋₁), and the reverse diffusion process 840 can be represented as p_{θ}(xₜ₋₁|xₜ). Further detail on the diffusion process is described with reference to FIG. 10.

A diffusion model 800 may be trained using both a forward diffusion process 830 and a reverse diffusion process 840. In one example, an untrained model is initialized. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 830 in N stages. In some cases, the forward diffusion process 830 is a fixed process where Gaussian noise is successively added to an image. In latent diffusion models, the Gaussian noise may be successively added to features (e.g., original image feature 820) in a latent space 825.

At each stage n, starting with stage N, a reverse diffusion process 840 is used to generate the image or image features at stage n−1. For example, the reverse diffusion process 840 can predict the noise that was added by the forward diffusion process 830, and the predicted noise can be removed from the image to obtain the predicted image. In some cases, an original image 805 is predicted at each stage of the training process.

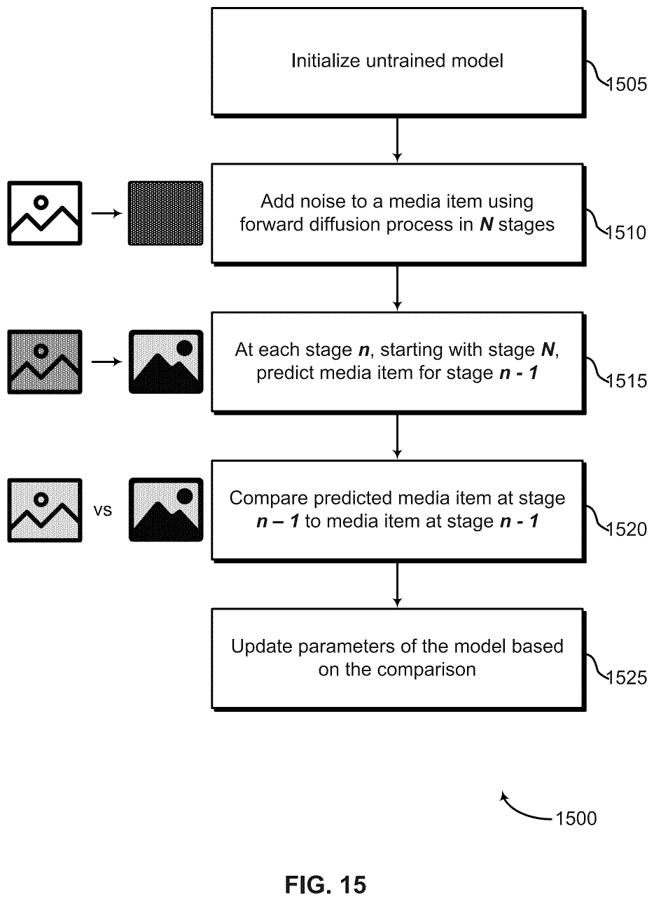

The training component (e.g., training component described with reference to FIG. 5) compares predicted image (or image features) at stage n−1 to an actual image (or image features), such as the image at stage n−1 or the original input image. For example, given observed data x, the diffusion model 800 may be trained to minimize the variational upper bound of the negative log-likelihood −log p_{θ}(x) of the training data. The training component then updates parameters of the diffusion model 800 based on the comparison. For example, parameters of a U-Net may be updated using gradient descent. Time-dependent parameters of the Gaussian transitions can also be learned. Further detail on training the diffusion model is described with reference to FIG. 15.

FIG. 9 shows an example of a U-Net 900 architecture according to aspects of the present disclosure. The example shown includes U-Net 900, input feature 905, initial neural network layer 910, intermediate feature 915, down-sampling layer 920, down-sampled feature 925, up-sampling process 930, up-sampled feature 935, skip connection 940, final neural network layer 945, and output feature 950.

In some examples, U-Net 900 is an example of the component that performs the reverse diffusion process 840 of diffusion model 800 described with reference to FIG. 8 and includes architectural elements of the image generation model 525 described with reference to FIG. 5. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input feature 905 having an initial resolution and an initial number of channels, and processes the input feature 905 using an initial neural network layer 910 (e.g., a convolutional network layer) to produce intermediate feature 915. The intermediate feature 915 is then down-sampled using a down-sampling layer 920 such that the down-sampled feature 925 has a resolution less than the initial resolution and a number of channels greater than the initial number of channels.

This process is repeated multiple times, and then the process is reversed. For example, the down-sampled feature 925 is up-sampled using up-sampling process 930 to obtain up-sampled feature 935. The up-sampled feature 935 can be combined with intermediate feature 915 having the same resolution and number of channels via a skip connection 940. These inputs are processed using a final neural network layer 945 to produce output feature 950. In some cases, the output feature 950 has the same resolution as the initial resolution and the same number of channels as the initial number of channels.

In some cases, U-Net 900 takes an additional input feature to produce conditionally generated output. For example, the additional input feature could include a vector representation of an input prompt. The additional input feature can be combined with the intermediate feature 915 within the neural network at one or more layers. For example, a cross-attention module can be used to combine the additional input features and the intermediate feature 915.

### Diffusion Process

FIG. 10 shows an example of a diffusion process 1000 according to aspects of the present disclosure. The example shown includes diffusion process 1000, forward diffusion process 1005, reverse diffusion process 1010, noisy image 1015, first intermediate image 1020, second intermediate image 1025, and original image 1030.

Diffusion process 1000 can include forward diffusion process 1005 for adding noise to original image 1030 (e.g., original image 805 described with reference to FIG. 8) or features (e.g., original image feature 820 described with reference to FIG. 8) in a latent space. In some aspects, diffusion process 1000 includes reverse diffusion process 1010 for denoising the noisy image 1015 (or image features) to obtain a denoised image (or original image 1030). The forward diffusion process 1005 can be represented as q(xₜ|xₜ₋₁), and the reverse diffusion process 1010 can be represented as p_{θ}(xₜ₋₁|xₜ). In some cases, the forward diffusion process 1005 is used during training to generate images with successively greater noise, and a neural network is trained to perform the reverse diffusion process 1010 (e.g., to successively remove the noise).

In an example forward diffusion process 1005 for a latent diffusion model (e.g., diffusion model 800 described with reference to FIG. 8), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1010. During the reverse diffusion process 1010, the diffusion model begins with noisy data x_{T}, such as a noisy image 1015 and denoises the data to obtain the p_{θ}(xₜ₋₁|xₜ). At each step t−1, the reverse diffusion process 1010 takes xₜ, such as the first intermediate image 1020, and t as input. Here, t represents a step in the sequence of transitions associated with different noise levels, The reverse diffusion process 1010 outputs xₜ₋₁, such as the second intermediate image 1025, iteratively until x_{T} is reverted back to x₀, the original image 1030. The reverse diffusion process 1010 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 12 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 13 )$$

where p(x_{T})=N(x_{T};0,l) is the pure noise distribution as the reverse diffusion process 1010 takes the outcome of the forward diffusion process 1005, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

### Image Editing

FIG. 11 shows an example of a method 1100 for generating a modified image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains an input image depicting a first element, a text description of the input image, and a modification prompt describing a second element different from the first element. In some cases, the operations of this step refer to, or may be performed by, a machine learning model as described with reference to FIGS. 3, 8, and 9. In some cases, the text description and the modification prompt may be substantially the same. In some cases, the modification prompt may be a simple phrase that describes a change of element depicted in the input image.

In some cases, the first element and the second element may include one or more image elements that are the same or different. For example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof. For example, the first element may refer to a fish, and the second element may refer to a steak.

At operation 1110, the system generates, using an inversion model, an intermediate output based on the input image and the text description, where the intermediate output represents the first element. In some cases, the operations of this step refer to, or may be performed by, an inversion model as described with reference to FIGS. 5-7. In some cases, the intermediate output may include latent representation, such as latent features, visual features, and/or latent codes of an image (e.g., the reconstructed image). In some cases, the intermediate output may be a predicted noise generated using the inversion model based on the input image and the text description of the input image.

At operation 1115, the system generates, using an image generation model, a synthetic image based on the intermediate output and the modification prompt, where the synthetic image replaces the first element from the input image with the second element from the modification prompt. In some cases, the operations of this step refer to, or may be performed by, an image generation model as described with reference to FIGS. 5-7. For example, the synthetic image includes image pixels generated by the image generation model. For example, modified image includes image pixels from the input image and image pixels generated by the image generation model.

### Training and Evaluation

In FIGS. 12-15, a method, apparatus, non-transitory computer readable medium, and system for image processing include obtaining a training set including a training image and a training description of the training image, generating, using an inversion model, an intermediate output based on the training image and the training description, generating, using an image generation model, a reconstructed image based on the intermediate output and the training description, and training the inversion model to perform image inversion.

According to some embodiments, a method, apparatus, non-transitory computer readable medium, and system for image processing include obtaining a training set including a training image and a training description of the image; generating, using an inversion model, an intermediate output based on the training image and the text description; generating, using an image generation model, a reconstructed image based on the intermediate output and the text description; and training the inversion model based on the training image and the reconstructed image.

Some examples of the method, apparatus, non-transitory computer readable medium, and system further include generating the training description based on the training image. Some examples of the method, apparatus, non-transitory computer readable medium, and system further include computing a reconstruction loss based on the training image and the reconstructed image. Some examples further include updating parameters of the inversion model based on the reconstruction loss.

Some examples of the method, apparatus, non-transitory computer readable medium, and system further include generating a modified image based on the intermediate output and a modification prompt. Some examples further include computing a modification loss based on the modified image and a ground-truth modified image. Some examples further include updating parameters of the inversion model based on the modification loss. Some examples of the method, apparatus, non-transitory computer readable medium, and system further include initializing the inversion model using parameters from the image generation model. In some aspects, the image generation model is fixed during the training of the inversion model.

FIG. 12 shows an example of a method 1200 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains a training set including a training image and a training description of the training image. In some cases, the operations of this step refer to, or may be performed by, a training component as described with reference to FIG. 8. In some cases, the training set is stored in the database as described with reference to FIG. 1.

At operation 1210, the system generates, using an inversion model, an intermediate output based on the training image and the training description. In some cases, the operations of this step refer to, or may be performed by, an inversion model as described with reference to FIGS. 5-7. In some cases, the intermediate output includes a predicted noise of the reconstruction of the input image. Further detail on the intermediate output is described with reference to FIGS. 6-7.

At operation 1215, the system generates, using an image generation model, a reconstructed image based on the intermediate output and the training description. In some cases, the operations of this step refer to, or may be performed by, an image generation model as described with reference to FIGS. 6-7. In some cases, the reconstructed image may be substantially the same as the input image. Further detail on the reconstruction image is described with reference to FIGS. 6-7.

At operation 1220, the system trains the inversion model to perform image inversion. In some cases, the operations of this step refer to, or may be performed by, a training component as described with reference to FIG. 5. In some cases, the inversion network of the inversion model is initialized from an SDXL-Turbo model, while the image generator of the inversion network is fixed throughout training. In some aspects, the learning rate of 10 and a batch of 10 are used to train the machine learning model.

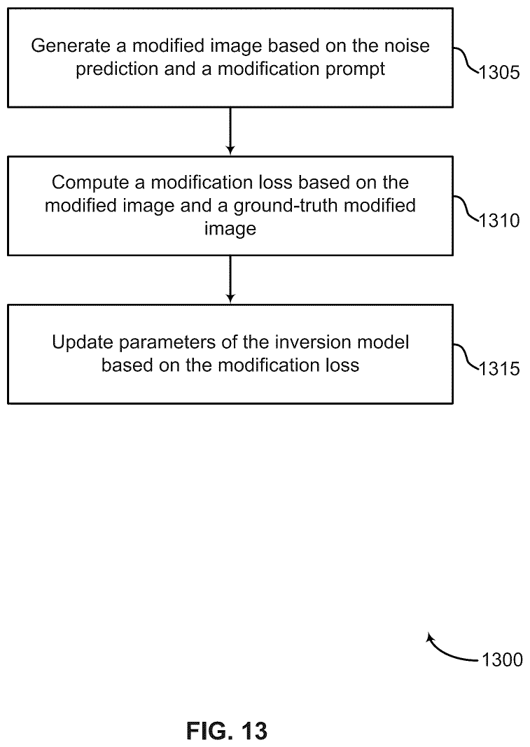

FIG. 13 shows an example of a method 1300 for training an inversion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system generates a modified image based on the intermediate output and a modification prompt. In some cases, the operations of this step refer to, or may be performed by, an image generation model as described with reference to FIGS. 5-7. At operation 1310, the system computes a modification loss based on the modified image and a ground-truth modified image. In some cases, the operations of this step refer to, or may be performed by, a training component as described with reference to FIG. 5. At operation 1315, the system updates the parameters of the inversion model based on the modification loss. In some cases, the operations of this step refer to, or may be performed by, a training component as described with reference to FIG. 5. Further detail on the loss functions to update parameters of the inversion model is described with FIG. 7.

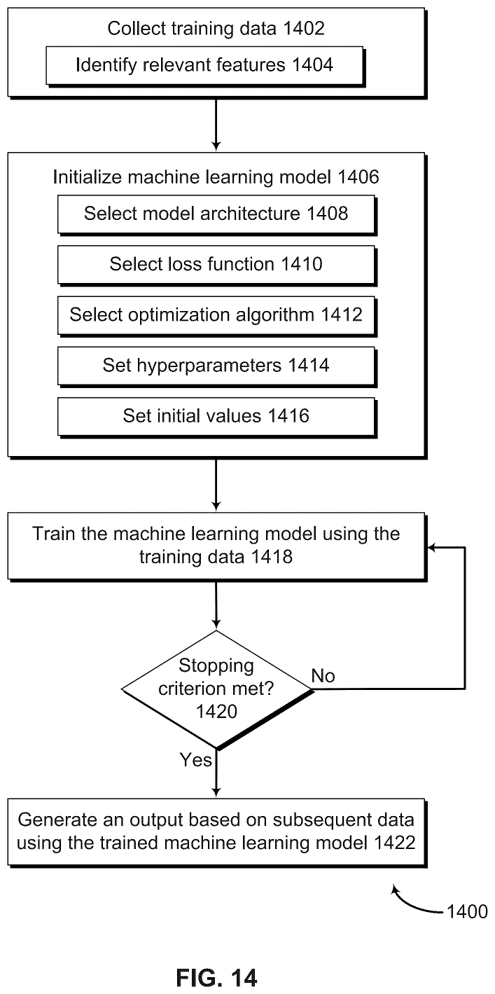

FIG. 14 shows an example of a flow diagram depicting an algorithm as a step-by-step procedure in an example implementation of operations performable for training a machine learning model according to aspects of the present disclosure. In some embodiments, the procedure 1400 describes an operation of the training component 535 described for configuring the image generation model 525 and/or the inversion model 520 as described with reference to FIG. 5. The procedure 1400 provides one or more examples of generating training data, use of the training data to train a machine-learning model, and use of the trained machine-learning model to perform a task.

To begin in this example, a machine-learning system collects training data (block 1402) to be used as a basis to train a machine-learning model, which defines what is being modeled. The training data is collected by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify and/or determine features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1410). The loss function is utilized to measure a difference between an output of the machine-learning model (e.g., the model predictions) and target values (e.g., as expressed by the training data) to be used to train the machine-learning model. Additionally, an optimization algorithm is selected (block 1412) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1416) examples of which include initializing weights and biases of nodes to increase efficiency in training and computational resources consumption as part of training. Hyperparameters are also set (block 1414) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1420), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), procedure 1400 continues the training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore once trained is configured to perform that task based on subsequent data received as an input and processed by the machine-learning model.

FIG. 15 shows an example of a method 1500 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1500 describes an operation of the training component 535 described for training the inversion model 520 as described with reference to FIG. 5. The method 1500 represents an example of training a reverse diffusion process as described above with reference to FIG. 10. In some examples, these operations are performed by a system including a processor executing a set of codes to control functional elements of an apparatus, such as the inversion model and/or the image generation model described in FIG. 5.

At operation 1505, the system initializes untrained model. In some cases, the operations of this step refer to, or may be performed by, a training component as described with reference to FIG. 5. Initialization can include defining the architecture of the model and establishing initial values for the model parameters. In some cases, the initialization can include defining hyper-parameters such as the number of layers, the resolution and channels of each layer block, the location of skip connections, and the like.

At operation 1510, the system adds noise to media item using forward diffusion process in N stages. In some cases, the operations of this step refer to, or may be performed by, a training component as described with reference to FIG. 5. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1515, the system at each stage n, starting with stage N, predict media item for stage n−1. In some cases, the operations of this step refer to, or may be performed by, a training component as described with reference to FIG. 5. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 5. For example, given observed data x, the diffusion model may be trained to minimize the variational upper bound of the negative log-likelihood −log p_{θ}(x) of the training data.

At operation 1525, the system updates parameters of the model based on the comparison. In some cases, the operations of this step refer to, or may be performed by, a training component as described with reference to FIG. 5. For example, parameters of a U-Net may be updated using gradient descent. Time-dependent parameters of the Gaussian transitions can also be learned.

### Computing Device

FIG. 16 shows an example of computing device 1600 according to aspects of the present disclosure. The example shown includes computing device 1600, processor 1605, memory subsystem 1610, communication interface 1615, I/O interface 1620, user interface component 1625, and channel 1630.

In some embodiments, computing device 1600 is an example of, or includes aspects of, the image processing apparatus described with reference to FIGS. 1 and 5. In some embodiments, computing device 1600 includes processor 1605 that can execute instructions stored in memory subsystem 1610 to obtain an input image, a text description, and a modification prompt, to generate an intermediate output based on the input image and the text description, and to generate a synthetic image based on the intermediate output and the modification prompt.

According to some embodiments, processor 1605 includes one or more processors. In some cases, processor 1605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1605 is configured to operate a memory array using a memory controller. In other cases, a memory controller is integrated into processor 1605. In some cases, processor 1605 is configured to execute computer-readable instructions stored in a memory to perform various functions. In some embodiments, processor 1605 includes special-purpose components for modem processing, baseband processing, digital signal processing, or transmission processing. Processor 1605 is an example of, or includes aspects of, the processor unit described with reference to FIG. 5.

According to some embodiments, memory subsystem 1610 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1610 is an example of, or includes aspects of, the memory unit described with reference to FIG. 5.

According to some embodiments, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1615.

According to some embodiments, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or hardware components controlled by the I/O controller. I/O interface 1620 is an example of, or includes aspects of, the I/O module described with reference to FIG. 5.

According to some embodiments, user interface component 1625 enables a user to interact with computing device 1600. In some cases, user interface component 1625 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3 and 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image depicting a first element and a modification prompt describing a second element different from the first element;
generating, using an inversion model, an intermediate output based on the input image, wherein the intermediate output comprises image features representing the image; and
generating, using an image generation model, a synthetic image based on the intermediate output and the modification prompt, wherein the synthetic image replaces the first element from the input image with the second element from the modification prompt.

2. The method of claim 1, further comprising:
obtaining the text description of the input image, wherein the intermediate output is generated based on the text description.

3. The method of claim 1, wherein:
the modification prompt comprises an edit to a text description of the input image.

4. The method of claim 1, wherein generating the synthetic image comprises:
iteratively alternating between generating successive intermediate outputs using the inversion model and the image generation model.

5. The method of claim 1, further comprising:
generating a reconstructed image based on the intermediate output, wherein the reconstructed image depicts the first element; and
generating a subsequent intermediate output based on the reconstructed image, wherein the synthetic image is based on the subsequent intermediate output.

6. The method of claim 1, wherein generating the synthetic image comprises:
obtaining a noise input; and
denoising the noise input based on the intermediate output.

7. The method of claim 1, wherein:
the inversion model is trained using a training set including a training image and a training description of the training image.

8. A method for training a machine learning model, the method comprising:
obtaining a training set including an input image and a text description of the training image;
generating an intermediate output based on the input image and the text description;
generating, using an image generation model, a reconstructed image based on the intermediate output and the text description; and
training, using the training set and the reconstructed image, the inversion model to perform image inversion.

9. The method of claim 8, wherein obtaining the training set comprises:
generating the text description based on the input image.

10. The method of claim 8, wherein training the inversion model comprises:
computing a reconstruction loss based on the input image and the reconstructed image; and
updating parameters of the inversion model based on the reconstruction loss.

11. The method of claim 8, wherein training the inversion model comprises:
generating a modified image based on the intermediate output and a modification prompt;
computing a modification loss based on the modified image and a ground-truth modified image; and
updating parameters of the inversion model based on the modification loss.

12. The method of claim 8, further comprising:
initializing the inversion model using parameters from the image generation model.

13. The method of claim 8, wherein:
the image generation model is frozen during the training of the inversion model.

14. An apparatus comprising:
at least one memory component;
at least one processing device coupled to the at least one memory component;
an inversion model comprising parameters stored in the at least one memory component and trained to generate an intermediate output based on an input image and a text description, wherein the intermediate output represents a first element of the input image; and
an image generation model comprising parameters stored in the at least one memory component and trained to generate a synthetic image based on the intermediate output and a modification prompt, wherein the synthetic image replaces the first element from the input image with a second element from the modification prompt.

15. The apparatus of claim 14, further comprising:
a caption generation model configured to generate the text description based on the input image.

16. The apparatus of claim 14, wherein:
the modification prompt comprises an edit to the text description.

17. The apparatus of claim 14, wherein generating the synthetic image comprises:
iteratively alternating between generating successive intermediate outputs using the inversion model and the image generation model.

18. The apparatus of claim 14, wherein the generating the synthetic image comprises:
generating a reconstructed image based on the intermediate output, wherein the reconstructed image depicts the first element; and
generating a subsequent intermediate output based on the reconstructed image, wherein the synthetic image is based on the subsequent intermediate output.

19. The apparatus of claim 14, wherein generating the synthetic image comprises:
obtaining a noise input; and
denoising the noise input based on the intermediate output.

20. The apparatus of claim 18, wherein:
the inversion model comprises a diffusion model.
